(19) United States
(12) Patent Application Publication
(10) Pub. No.: US 2007/0276935 A1
(43) Pub. Date: Nov. 29, 2007

(54) Method for Processing Asynchronous Communication Mechanism Based on Simple Network Management Protocol

(76) Inventor: Guangwei Liu, Guangdong (CN)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/547,704

(22) PCT Filed: Jun. 8, 2005
(86) PCT No.: PCT/CN05/00813

§ 371 Date: Jun. 18, 2007

(30) Foreign Application Priority Data
Jun. 8, 2004 (CN) 200410048650.X

(51) Int. Cl. H04L 12/24

(52) U.S. Cl. 709/223

(57) ABSTRACT

A method for processing asynchronous communication mechanism, including steps of: allocating identifiers for different operation command message; on receiving an operation command message transmitted by a manager module, an agent module determining whether the operation command is in need of an asynchronous notification, if the operation command is in need of the asynchronous notification, the agent module informing the manager module that the operation command has been performed; on receiving the information, the manager module waiting for the agent module to feed back the operation results; the agent module obtaining the identifier corresponding to the operation command message, and transmitting the operation results to the manager module through a TRAP message containing the identifier; and the manager module identifying the TRAP message through the identifier. The method enables the manager module to identify the TRAP messages easily and improves the efficiency of processing operations in need of multiple feedbacks.

### FIELD OF THE INVENTION

The present invention relates to the field of communication technologies, and more particularly, to a method for processing asynchronous communication mechanism processing based on Simple Network Management Protocol (SNMP).

### BACKGROUND OF THE INVENTION

Along with the rapid development of network technology, numbers and scales of networks are becoming lager and lager. Devices in the networks are from various different manufactures, so it is very important to manage these devices. For this purpose, the Internet Engineering Task Force (IETF) defined the Simple Network Management Protocol (SNMP). The SNMP is independent from protocols of lower layers, so it is not only adopted in the Internet, but also adopted in other various networks such as a telephone network.

The network management entity based on SNMP includes two parts; a network management station and a managed network unit; and the managed network unit is also called a managed device. An SNMP manager module, abbreviated as a manager module hereinafter, is run at the network management station, and an SNMP agent module, abbreviated as an agent module hereinafter, is run at the managed device. The network management station can implement management functions such as monitoring the state of the managed device, modifying the configurations of the managed device and receiving network event alarms through interactions between the manager module and the agent module.

There are two approaches that can be employed to implement communication between the manager module and the agent module. According to one approach, the manager module transmits a request to the agent module to query or to configure some detailed parameter values, and the agent module returns the corresponding data in response to the request or sets the value of the managed object; according to the other approach, in the case that the manager module does not transmit any request, the agent module reports on its own initiative to the manager module that some certain events have occurs.

At present, the SNMP has three versions: V1, V2 and V3. The V1 version defines five types of massages: GET-REQUEST, GET-NEXT-REQUEST, SET-REQUEST, GET-RESPONSE and TRAP. The V2 version of SNMP adds a GET-BULK-REQUEST message and an INFORM-REQUEST message based on the V1 version. The V3 version adds a user-oriented processing security mechanism based on the V2 version, without adding any new message.

Referring to FIG. 1a and FIG. 1b, the SNMP message includes three parts: a public SNMP header, a message header and a variable. Moreover, the public SNMP headers of all the SNMP messages are uniform, i.e. the public SNMP headers of all the SNMP messages include three fields: Version, Community and Protocol Data Unit Type. Referring to FIG. 1c and FIG. 1d, in the five messages defined by V1 version of SNMP, the message header of the TRAP message includes five fields: Enterprise, Agent Address, TRAP Type, Specific Code and Timestamp; and the message headers of the other four request messages include three fields: Request Identifier, Error State and Error Index. The variable part can carry content information or user-defined meanings of the related fields.

The SNMP adopts an asynchronous Client/Server method. Specifically, according to the asynchronous Client/Server method, the manager module transmits an operation command message, such as GET-REQUEST, GET-NEXT-REQUEST, SET-REQUEST or GET-RESPONSE to the agent module; on receiving the message, the agent module does not respond the manager module directly, but transmits a response to the manager module with a TRAP message after a period of time.

In the prior SNMP protocol applications, there are two solutions for transmitting the response according to different types of command messages.

In accordance with the first solution, an asynchronous mode is adopted to feed back the results. For example, the SNMP manager module transmits a SET-REQUEAT command; the agent module checks the command, if the command is determined as a command in need of an asynchronous notification, the agent module directly feeds back a piece of information of “the operation has been performed” in the response message for SET-REQUEST; after the operation results are generated, the agent module transmits to the manager module a TRAP message, carrying the operation results; on receiving the TRAP message, the manager module performs task identification to the TRAP message, i.e. determines whether the object identifier, the error code and the operation results saved by the manager module are consistent with the object identifier, the error code and the operation results in the variable binding list of the TRAP message; if the object identifier, the error code and the operation results saved by the manager module are consistent with the object identifier, the error code and the operation results in the variable binding list of the TRAP message, the manager module identifies the request message that the TRAP message corresponds to, and then displays the operation results carried in the TRAP message to the user.

At present, since the task identification mechanism to the TRAP message has not been defined, in the first solution, the manager module needs to seriatim identify and match the command words and the operation entity parameters in the TRAP messages. In this way, there may be multiple TRAP messages with a same matching content, so that the matching is not accurate; and the contents of the messages need to be compared on by one, so that the efficiency is relatively low.

The second solution is applicable for some certain request commands in need of that the agent module feeds back for several times. The SNMP prescribes that the request commands and the responses corresponding to the request commands must be one-to-one correspondent. After receiving the request command of the manager module, if the agent module cannot obtain all the operation results within the stated time, it is possible that the agent module only responds a part of the operation results corresponding to the request command; hereafter, if the agent module obtains another part of the operation results corresponding to the request command, and if the manager module does not transmit the request command repeatedly, the agent module can not transmit this part of the operation results to the manager module.

For example, when some files are transferred with File Transfer Protocol (FTP), the SNMP manager must transmit a query command periodically to make the agent feed back the file transport pace in time.

For the second solution, since it is necessary that multiple bidirectional message interaction between the manager module and the agent module should be performed, the efficient is relatively low and real-time performance is not good. Moreover, if the time interval of the manager module transmitting the query to the agent module is shorted to enhance the real-time performance, it is possible that the agent module has not obtained the following operation results at all because the time interval is too short, which will possibly result in an invalid query.

### SUMMARY OF THE INVENTION

In view of this, the present invention provides a method for processing asynchronous communication mechanism based on Simple Network Management Protocol to make the manager unit identify the TRAP messages easily and accurately, and to improve the identification efficiency.

The technical solution in accordance with the embodiments of the present invention is as follows:

A method for processing asynchronous communication mechanism based on Simple Network Management Protocol (SNMP), being applied to communication process between a manager module and an agent module, includes: allocating TRAP message identifiers for different operation command messages;

on receiving an operation command message transmitted by a manager module, an agent module determining whether the operation command is in need of an asynchronous notification, if the operation command is in need of the asynchronous notification, the agent module informing the manager module that the operation command has been performed;

on receiving the information, the manager module waiting for the agent module to feed back results of the operation;

the agent module obtaining the TRAP message identifier corresponding to the operation command message, and transmitting the results of the current operation to the manager module through a TRAP message containing the TRAP message identifier; and the manager module identifying the TRAP message through the TRAP message identifier.

The step of allocating the TRAP message identifiers for different operation command messages comprises:

configuring the mapping relationship between request identifiers carried in the operation command messages and the TRAP message identifiers.

A command message identifier field is added in a variable binding list of a variable part in the TRAP message to carry the TRAP message identifier.

The TRAP message transmitted from the agent module to the manager module in the step C further comprises:

an end mark and a current message sequence number;

the end mark is used for indicating whether the TRAP message is the last message for the operation command message, and the current message sequence number is used for expressing the sequence number of the current response message to the manager module generated by the agent module;

Step C further comprises:

the manager module processing the current TRAP message according to the current message sequence number therein, and determining whether all the operation results are reported according to the end mark in the TRAP message, if all the operation results are not reported, returning to step B.

The end mark and the current message sequence number are contained in a variable binding aggregate of a variable part in the TRAP message.

It could be discovered through comparison that the difference between the technical solution of the present invention and the prior art is that, three fields: the command message identifier, the end mark and the current message sequence number are defined in the content of the TRAP message. The command message identifier is used for accurately matching the long time-operated command message and the TRAP message responding the command message, the combination of the above-mentioned fields can realize multiple feedbacks to one command message.

The difference of the technical solution brings effects that the accurate matching of the command message and the TRAP response message can improve the performance efficiency and the reliability of the message matching, and that the multiple responses to the same command can reduce the times of message interactions and save network bandwidth.

### BRIEF DESCRIPTION OF THE DRAWINGS

FIG. 1 includes four parts: 1a, 1b, 1c and 1d, wherein, FIG. 1a illustrates the prior SNMP message format; FIG. 1b is the format of an SNMP header; FIG. 1c illustrates the format of a message header in a TRAP message; FIG. 1d illustrate the format of a message header in GET-REQUEST, GET-NEXT-REQUEST, SET-REQUEST, and GET-RESPONSE;

FIG. 2 illustrates the format of a variable part in an SNMP message in accordance with the embodiment of the present invention;

FIG. 3 is a schematic diagram illustrating the process in accordance with the embodiment of the present invention;

FIG. 4 is a message sequence chart illustrating an embodiment according to the method for processing asynchronous communication mechanism based on SNMP.

### DETAILED DESCRIPTION OF THE INVENTION

The present invention will be further described in detail hereinafter with reference to the accompanying drawings and embodiments to make the technical solution and the merits of the present invention clearer.

The key idea of the present invention includes: allocating TRAP messages identifiers for different operation command messages; on receiving an operation command message transmitted by a manager module, an agent module determines whether the operation command is in need of an asynchronous notification; if the operation command is in need of the asynchronous notification, the agent module will inform the manager module that the operation command has been performed; on receiving the information, the manager module waits for the agent module to feed back operation results, and hereafter, the agent module transmits some TRAP messages, carrying the TRAP message identifier corresponding to the operation command message, to the manager module in order to feed back the operation results to the manager module.

Moreover, the TRAP identifiers allocated for different operation command messages can be saved in the manager module and the agent module simultaneously, and also can be saved in a physical entity that communicates with the manager module and the agent module.

The Request Identifier field in the prior operation command message can be used to identify the current operation command message, while there is not any field in the TRAP message to indicate which operation command message the current TRAP message corresponds to. According to the embodiment of the present invention, a field in the variable part of the TRAP message, i.e. a command message identifier, is defined for the manager module to identify which operation command message the current TRAP corresponds to. In other words, a field can be defined in the variable part of the TRAP message as the identifiers of the TRAP messages corresponding to different operation command messages. The content of the field is called a command message identifier. A mapping relationship between the request identifiers and the command message identifiers is also set in advance. According to the mapping relationship, the agent module allocates the command message identifier in the TRAP message that is fed back from the agent module to the manager module, while the manager module determines which operation command message the received TRAP message corresponds to.

Since the agent module needs to feed back multiple TRAP messages for one operation command message of the manager module, a current message sequence number field and an end mark field are set in the variable part of the TRAP message. The current message sequence number is used for indicating the sequence number of the TRAP message corresponding to one GET-REQUEST, and the end mark is used for indicating whether there is any following TRAP message to be reported.

On receiving the TRAP message containing the command message identifier, according to the mapping relationship between the request identifiers and the command message identifiers, the current message sequence number and the end mark, the manager module obtains the request identifier corresponding to the command message identifier in the TRAP message, and accordingly identifies the operation command message corresponding to the TRAP message; moreover, the manager module processes the current TRAP message according to the current message sequence number, and determines whether the operation results corresponding to the operation command message are all reported according to the end mark in the TRAP message.

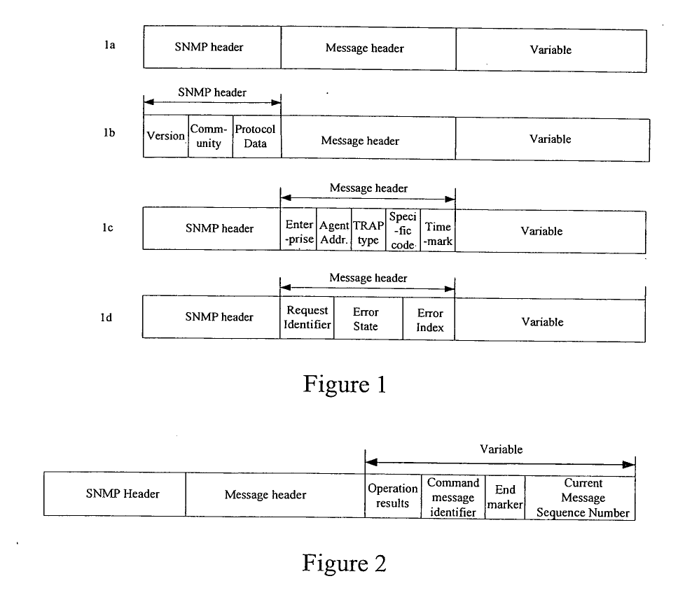

Referring to FIG. 2, three variable bindings are added in the variable binding aggregate in the variable part of the TRAP message, which are the command message identifier, the current message sequence number and the end mark. All of the three fields can be expressed by an integer variable. The request identifier and the corresponding command message identifier can be uniform for convenience of identification, i.e. the command message identifier in the TRAP message corresponding to the operation command massage can be set as same as the request identifier in the operation command message. In this way, according to the command message identifier, the manager module can directly determine which operation command message the TRAP message corresponds to.

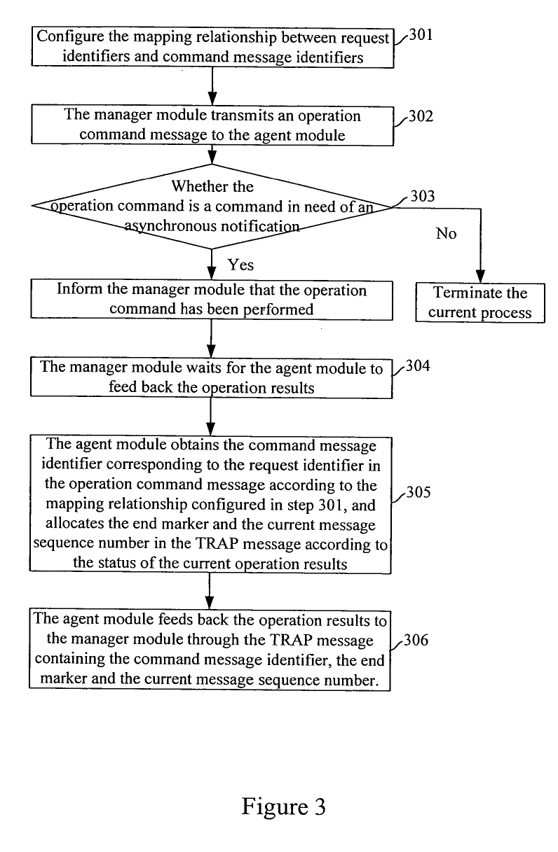

As shown in FIG. 3, the method according to the embodiment of the present invention includes the following steps.

Step 301: the mapping relationship between request identifiers and command message identifiers is configured.

Step 302: the manager module transmits an operation command message to the agent module.

Step 303: on receiving the operation command message, the agent module determines whether the operation command is in need of an asynchronous notification; if the operation command is in need of an asynchronous notification, the agent module informs the manager module that the operation command has been performed, otherwise, terminates the flow;

Step 304: the manager module waits for the agent module to feed back the operation results.

Step 305: the agent module obtains the command message identifier corresponding to the request identifier carried in the operation command message according to the mapping relationship configured in step 301, and allocates the end mark and the current message sequence number in the TRAP message according to the status of the current operation results.

Step 306: the agent module feeds back the operation results to the manager module through the TRAP message containing the command message identifier, the end mark and the current message sequence number.

Step 307: on receiving the TRAP message, the manager module obtains the request identifier corresponding to the command message identifier carried in the TRAP message according to the mapping relationship, and identifies the operation command message corresponding to the TRAP message; moreover, the manager module processes the current message according to the current message sequence number, and determines whether the operation results have all been reported according to the end mark in the TRAP message, if the report is not finished, returns to step 304.

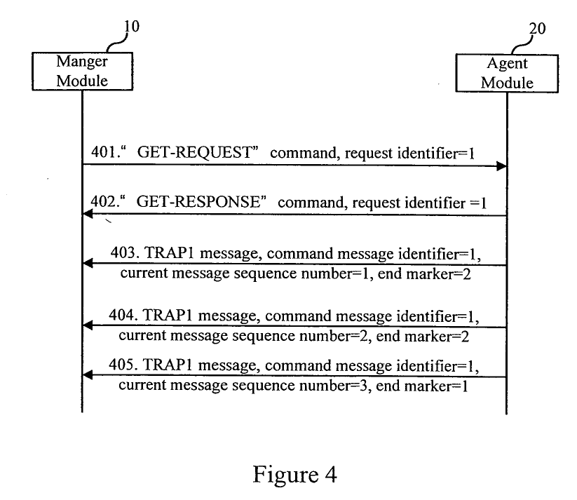

FIG. 4 is a message sequence chart illustrating an embodiment according to the method for processing asynchronous communication mechanism based on SNMP.

In this embodiment, the following conventions are supposed.

If the request identifier carried in the GET-REQUEST is 1, the command message identifier carried in the TRAP message is also allocated as 1. If the current message sequence number in the TRAP message is 1, the current TRAP message is the first TRAP message generated by the agent module for one GET-REQUEST; if the current message sequence number is 2, the current TRAP message is the second TRAP message generated by the agent module for one GET-REQUEST, and the rest can be deduced by analogy. If the end mark is 1, there is no following TRAP message for the same GET-REQUEST; while if the end mark is 2, there is a following TRAP message for the same GET-REQUEST. In practical applications, the detailed values are not limited to the above-mentioned embodiment, and the values can be configured according to the demands of the users. As shown in FIG. 4, the detailed implementation of the method in accordance with the embodiment of the present invention includes the following steps.

Step 401, the manager module 10 transmits a GET-REQUEST command to the agent module 20, requesting to obtain certain management information, e.g. a file transport pace of FTP. The request identifier in the GET-REQUEST command is 1, indicating that the message is the first command transmitted from the manager module 10 to the agent module 20.

Step 402: the agent module 20 analyzes the received GET-REQUEST command, if the agent module 20 finds that multiple feedback responses need to be returned, the agent module 20 returns a GET-REQUEST response to the manager module 10 at once to inform the manager module 20 that the command has been performed. The request identifier in the response is also 1, indicating that the response is for the command whose request identifier is 1.

Step 403: on obtaining a part of management information, the agent module 20 transmits the first TRAP message to the manager module 10. The command message identifier in the variable part of the TRAP message is 1, the current message sequence number field is 1 and the end mark is 2.

It needs to be explained that, the command message identifier is an integer variable; and if the value of the command message identifier is 1, the current TRAP message is a response to the GET-REQUEST command whose request identifier is 1. It should be noted that since no request identifier is defined in the message header of the TRAP message, the command message identifier field is defined in the variable part to match the TRAP message to its corresponding command message. The command message identifier of the TRAP message has the value of the request identifier of the command that the TRAP message corresponds to. The current message sequence number is an integer variable; and if the value of the current message sequence number is 1, the TRAP message is the first message of the multiple feedbacks for the GET-REQUEST command. The end mark is also an integer variable; and if the value of the end mark is 2, the feedback is not finished, and the following TRAP messages will be sent unceasingly.

Step 404, on obtaining another part of management information, the agent module 20 transmits the second TRAP message to the manager module 10. The command message identifier in the variable part of the TRAP message is 1, the current message sequence number is 2, and the end mark is 2. As explained in Step 403, the current TRAP message is the second TRAP feedback to the command whose request identifier is 1, and the following TRAP messages will be fed back unceasingly.

Step 405, on receiving all the rest management information, the agent module 20 transmits the third TRAP message to the manager module 10. The command message identifier in the variable part of the TRAP message is 1, the current message sequence number is 3, and the end mark is 1. As explained in step 403, the current TRAP message is the third TRAP feedback to the command whose request identifier is 1, and there is no following TRAP message.

Thus, the whole interaction process between the manager module 10 and the agent module 20 comes to an end. It can be seen from the above-mentioned solution that, the method in accordance with the embodiment of the present invention achieves the convenient matching and the message sorting by defining three fields with specific meanings: the command identifier, the end mark and the current message sequence number. Moreover, the mechanism defined in accordance with the embodiment of the present invention can effectively reduce message interactions in the case that multiple feedbacks are needed. The manager module can determine whether all the operation results have been reported every time the manager module receives the feedback message; if all the operation results have not been reported, the manager module only needs to keep on waiting instead of retransmitting the command to query the results. In a general way, according to the solution, when the number of the feedback messages for one command is N, the number of the interactive messages that can be reduced is N−1.

The present invention has been illustrated and described with reference to some preferable embodiments of the present invention, but those skilled in the art should understand that various changes of equivalent parts to the format and the details of the invention can be made within the spirit and the scope of the present invention as defined by the appended claims.

1. A method for processing asynchronous communication mechanism, comprising:
allocating TRAP message identifiers for different operation command messages;
on receiving an operation command message transmitted by a manager module, an agent module determining whether the operation command is in need of an asynchronous notification, if the operation command is in need of the asynchronous notification, the agent module informing the manager module that the operation command has been performed;
on receiving the information, the manager module waiting for the agent module to feed back results of the operation;
the agent module obtaining the TRAP message identifier corresponding to the operation command message, and transmitting the results of the current operation to the manager module through a TRAP message containing the TRAP message identifier; and
the manager module identifying the TRAP message through the TRAP message identifier.

2. The method according to claim 1, wherein, the step of allocating the TRAP message identifiers for different operation command messages comprises: configuring the mapping relationship between request identifiers carried in the operation command messages and the TRAP message identifiers.

3. The method according to claim 2, wherein, a command message identifier field is added in a variable binding list of a variable part in the TRAP message to carry the TRAP message identifier.

4. The method according to claim 1, wherein, the TRAP message transmitted from the agent module to the manager module further comprises:
an end mark, for indicating whether the TRAP message is the last message for the operation command message; and
a current message sequence number, for expressing the sequence number of the current response message to the manager module generated by the agent module.

5. The method according to claim 4, wherein, the end mark and the current message sequence number are contained in a variable binding aggregate of a variable part in the TRAP message.

6. The method according to claim 4, wherein, the step of the manager module identifying the TRAP message through the TRAP message identifier further comprises:
the manager module processing the current TRAP message according to the current message sequence number therein, and determining whether all the operation results are reported according to the end mark in the TRAP message, if all the operation results are not reported, the manager module waiting for the agent module to feed back the results of the operation.

7. The method according to claim 3, wherein, the TRAP message transmitted from the agent module to the manager module further comprises:
an end mark, for indicating whether the TRAP message is the last message for the operation command message; and
a current message sequence number, for expressing the sequence number of the current response message to the manager module generated by the agent module.

8. The method according to claim 7, wherein, the end mark and the current message sequence number are contained in a variable binding aggregate of a variable part in the TRAP message.

9. The method according to claim 7, wherein, the step of the manager module identifying the TRAP message through the TRAP message identifier further comprises:
the manager module processing the current TRAP message according to the current message sequence number therein, and determining whether all the operation results are reported according to the end mark in the TRAP message, if all the operation results are not reported, the manager module waiting for the agent module to feed back the results of the operation.
